(19) United States
(12) Patent Application Publication
(10) Pub. No.: US 2013/0269503 A1
(43) Pub. Date: Oct. 17, 2013

(54) AUDIO-OPTICAL CONVERSION DEVICE AND CONVERSION METHOD THEREOF

(71) Applicant: Louis Liu, Taipei City (TW)

(72) Inventor: Louis Liu, Taipei City (TW)

(21) Appl. No.: 13/448,792

(22) Filed: Apr. 17, 2012

(51) Int. Cl. G10H 1/00

(52) U.S. Cl. 84/464 R

(57) ABSTRACT

An audio-optical conversion device and a conversion method thereof, comprising: a plurality of audio intensity identifiers, a plurality of light source drivers, and a plurality of light emitting elements. The audio intensity identifiers receive a sound signal, and each audio intensity identifier identifies from the sound signal audio signals of different frequencies and different volume intensities, and then outputs the audio signals. Each audio intensity identifier is connected directly to the light source driver, to receive the corresponding audio signal, and converts it into a corresponding electrical signal. Each light source driver is connected to each light emitting element, to receive corresponding electrical signal, and generates a corresponding optical signal, hereby achieving a stereo and in-depth audio-optical effect of a real scene.

### BACKGROUND OF THE INVENTION

1. Field of the Invention

The present invention relates to a conversion technology, and in particular to an audio-optical conversion device and conversion method thereof.

2. The Prior Arts

The commercial applications of LEDs started in the 60', and due to its various advantages of high light intensity, long service life, low power consumption, vibration proof, and low heat dissipation, it has been used widely in various products of our daily lives, such as indication lights or light source of household electric appliances and various instruments. In recent years, due to its characteristics of multi-color and high illumination, it has been used extensively in outdoor displayer, such as large-sized outdoor billboard, and traffic lights. Since red, blue, and green are the three original colors, such that for a full-color outdoor billboard, blue or green LEDs of high illumination are indispensable.

In the prior art, in general, LED lighting system is utilized in large plaza, billboard, or other locations applicable, such as restaurants, auditoriums, pubs, or concert halls. However, on such occasions, the lighting effect is controlled manually, or by electrical circuits, and signals processed by micro-chips are used to drive LEDs, therefore illumination variations of LED lights can not be realized in synchronization with that of the audio effect, such that it may either lag behind or proceed in advance. In other words, in practical application on the scene, the lighting effects can not work in synchronism with the audio effects, to achieve a sense of stereo and in-depth of the real scene, so that the overall audio-optical effects produced on the scene are not quite satisfactory.

Therefore, presently, the design and performance of audio and optical devices are not quite satisfactory, and it has much room for improvements.

### SUMMARY OF THE INVENTION

In view of the problems and drawbacks of the prior art, the present invention provides an audio-optical conversion device and conversion method thereof, so as to overcome the shortcomings of the prior art.

A major objective of the present invention is to provide an audio-optical conversion device and conversion method thereof. Wherein, an audio intensity identifier is used to identify from a sound signal the audio signals of various frequencies and volume intensities, and to produce optical signals of various colors and illuminations, in achieving a lively, ideal, and in-depth audio-optical effect of the real scene.

In order to achieve the objective mentioned above, the present invention provides an audio-optical conversion device, comprising: a plurality of audio intensity identifier, a plurality of light source drivers, and a plurality of light emitting elements. Wherein, the audio intensity identifier is used to receive a sound signal, to identify from the sound signal the audio signals of various frequencies and volume intensities, and then output the audio signals. Each of the audio intensity identifiers is connected directly to each light source driver, such that each light source driver receives the corresponding audio signal and converts it to an electrical signal. Each of the light source drivers is connected to each of the light emitting elements, such that each light emitting element receives the corresponding electrical signal, and generates a corresponding optical signal. Wherein, the higher the frequency of the audio signal, the cooler the color of the corresponding optical signal; the lower the frequency of the audio signal, the warmer the color of the corresponding optical signal. Moreover, the greater the volume intensity of the audio signal, the brighter the corresponding optical signal; and the smaller the volume intensity of the audio signal, the dimmer the corresponding optical signal.

The present invention also provides an audio-optical conversion method, comprising the following steps. Firstly, the audio intensity identifier receives a sound signal, identifies from it a plurality of audio signals of various frequencies and volume intensities, and then outputs the audio signals. Then, the light source driver receives the audio signal, and converts it into a corresponding electrical signal. Finally, the light emitting element receives the electrical signal and converts it into an optical signal. Wherein, the higher the frequency of the audio signal, the cooler the color of the corresponding optical signal; the lower the frequency of the audio signal, the warmer the color of the corresponding optical signal. Furthermore, the greater the volume intensity of the audio signal, the brighter the corresponding optical signal; and the smaller the volume intensity of the audio signal, the dimmer the corresponding optical signal.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from this detailed descriptions.

### BRIEF DESCRIPTION OF THE DRAWINGS

The related drawings in connection with the detailed descriptions of the present invention to be made later are described briefly as follows, in which:

FIG. 1 is a block diagram of an audio-optical conversion device according to the present invention;

FIG. 2 is an audio signal waveform diagram corresponding to optical signal from warm colors to cool colors according to the present invention;

FIG. 3 is an audio signal waveform diagram corresponding to optical signal from cool colors to warm colors according to the present invention;

FIG. 4 is an audio signal waveform diagram corresponding to optical signal from bright to dim according to the present invention; and

FIG. 5 is an audio signal waveform diagram corresponding to optical signal from dim to bright according to the present invention.

### DETAILED DESCRIPTION OF THE PREFERRED EMBODIMENT

The purpose, construction, features, functions and advantages of the present invention can be appreciated and understood more thoroughly through the following detailed descriptions with reference to the attached drawings.

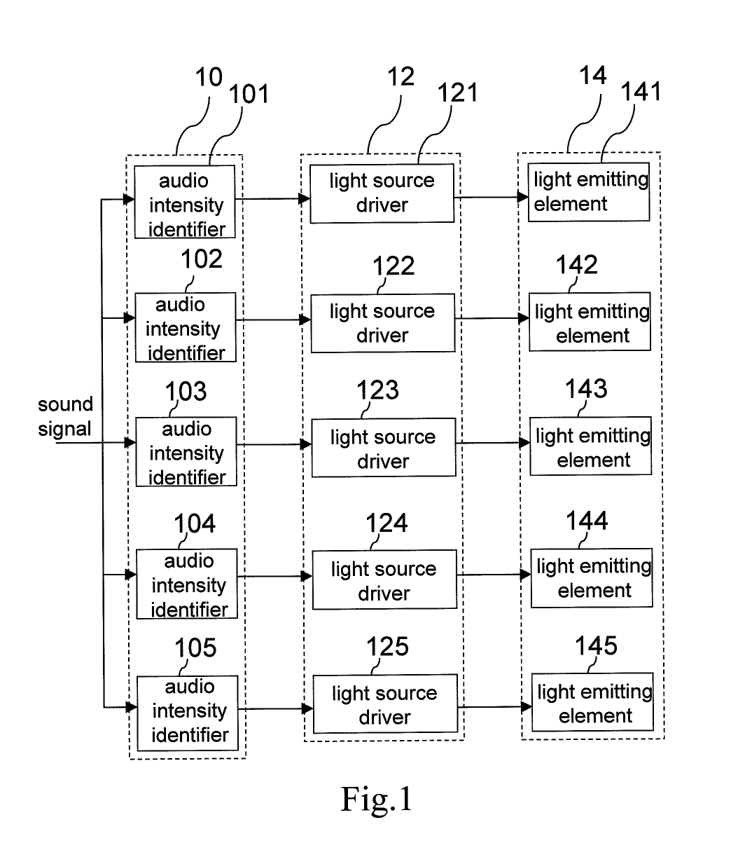

Refer to FIG. 1 for a block diagram of an audio-optical conversion device according to the present invention. As shown in FIG. 1, in the present invention, the audio-optical conversion device is driven in an analog approach, as such, its output signal is of real-time nature. The present invention includes a plurality of audio intensity identifiers 10, a plurality of light source driver 12, and a plurality of light emitting elements 14. Herein, for the light emitting element 14, the light-emitting-diode (LED) is taken as an example for explanation. The audio intensity identifiers 10 are used to receive a sound signal, and identify from it audio signals of different frequencies and different volume intensities, then outputs the audio signals. Each of the light source drivers 12 is connected directly to each of the audio intensity identifiers 10, to receive the corresponding audio signal, and converts it into an electrical signal. Each of the light emitting elements 14 is connected to each of the light source drivers 12, to receive the corresponding electrical signal, and to generate respectively a corresponding optical signal. Wherein, the light source driver 12 may drive the light emitting elements 14 by means of a current or a voltage, such that the electrical signal can be a current signal or a voltage signal. In addition, since each optical signal corresponds to a specific color, but that is not limited to the same color, therefore, the present invention is scalable.

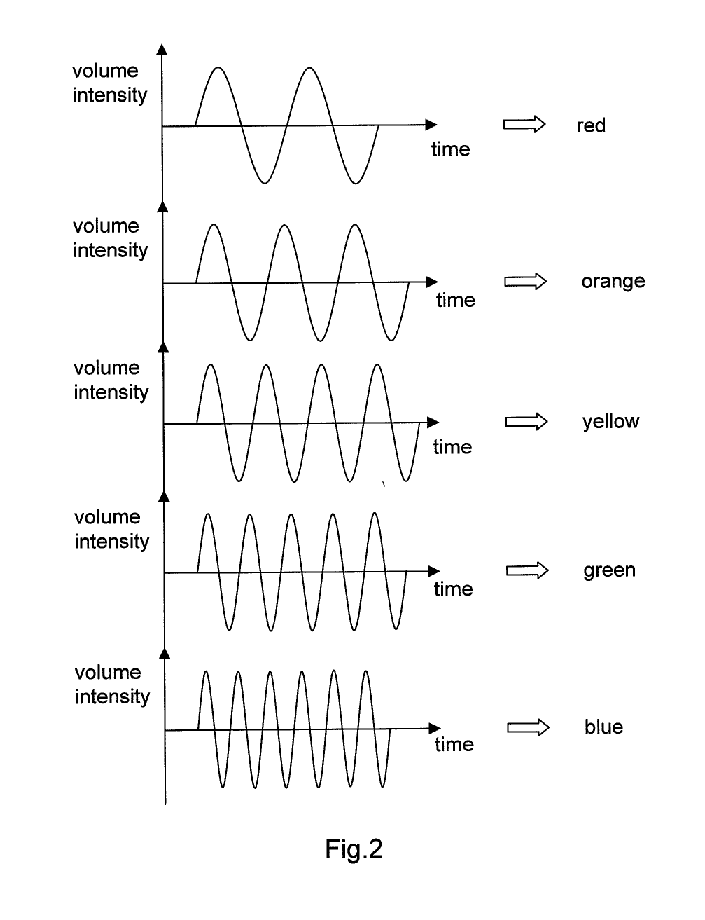

In the following, refer to FIGS. 2 to 5, that correspond to FIG. 1. As shown in FIG. 1, a plurality of audio intensity identifiers 10, light source drivers 12, and light emitting elements 14 are provided, herein a quantity of 5 is taken as an example for explanation. To facilitate explaining operations of the present invention. in FIG. 1 is shown the audio intensity identifiers 10 from top to bottom in sequence as audio intensity identifiers 101˜105, each corresponds to and is connected to each of light source drivers 121˜125. The light source drivers 121˜125 each corresponds to and is connected to each of light emitting elements 141˜145. In operations, firstly, all the audio intensity identifiers 101˜105 receive the same sound signal, to identify from it different audio signals of different frequencies and different volume intensities, and then output the audio signals. Then, each of the light source drivers 121˜125 receives the respective audio signal, and converts it into a corresponding electrical signal. And Finally, each of the light emitting elements 141˜145 receives the respective electrical signal, and converts it into a corresponding optical signal.

In the present invention, different optical signals correspond to different colors, that can be classified into warm colors, such as red, orange, yellow, and pink; and cool colors, such as cyan, blue, purple, green, aquamarine, and black. In the present invention, frequency of audio signal is related to color of corresponding optical signal. By way of example, bass drum is of a low frequency of 40˜50 Hz, bass is of a middle low frequency of 70˜280 Hz, soprano is of a middle frequency of 280˜900 Hz, cymbal is of a middle frequency of 400˜1000 Hz, and piccolo is of a middle high frequency of 600˜3500 Hz. Through combining the sounds and voices mentioned above into music, to serves as a sound signal. Then, upon receiving and processing the sound signal by the audio intensity identifiers 101˜105, the audio signals thus obtained can be filtered to produce sounds and voices of various frequencies mentioned above. Refer to FIG. 2 for an audio signal waveform diagram of frequency corresponding to optical signal from warm colors to cool colors according to the present invention. As shown in FIG. 2, the colors of corresponding optical signals from top to bottom (of increasing frequency) is of bass drum, bass, soprano, cymbal, and piccolo, namely, in optical frequency from low to high. As such, the colors of optical signals produced by the light emitting elements 141˜145 from top to bottom as based on frequency are in a sequence from warm to cool as red, orange, yellow, green, and blue. In other words, the lower the frequency of the audio signal, the warmer the color of the corresponding optical signal; and the higher the frequency of the audio signal, the cooler the color of the corresponding optical signal.

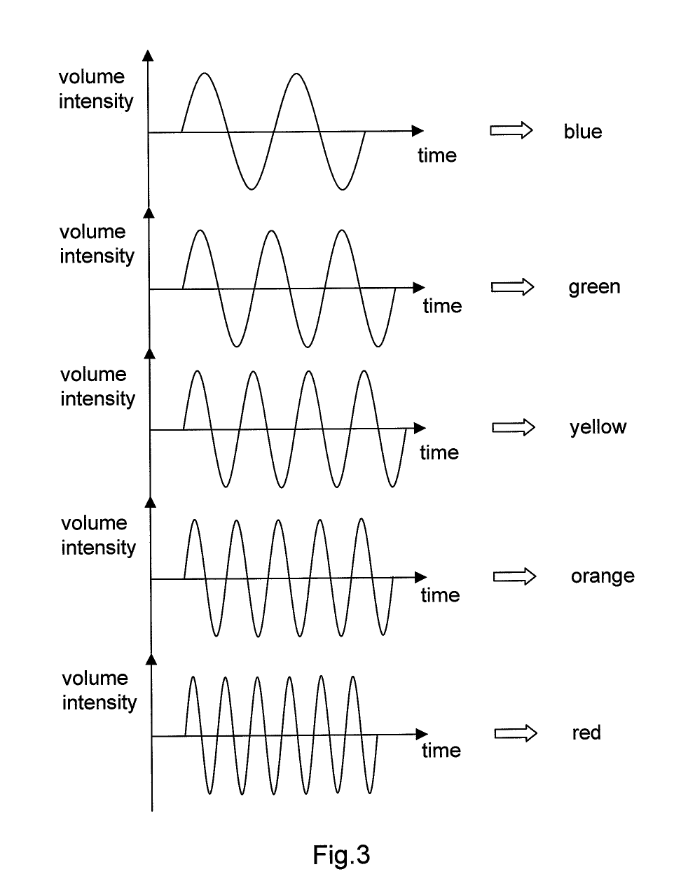

In addition, it can be set to a scheme that, the lower the frequency of the audio signal, the cooler the color of the corresponding optical signal; and the higher the frequency of the audio signal, the warmer the color of the corresponding optical signal. As shown in FIG. 3, from top to bottom is a sequence of audio signals from low to high frequency. Then, the colors of the corresponding optical signals produced by light emitting elements 141˜145 are as shown from top to bottom in a cooler to warmer sequence such as: blue, green, yellow, orange, and red.

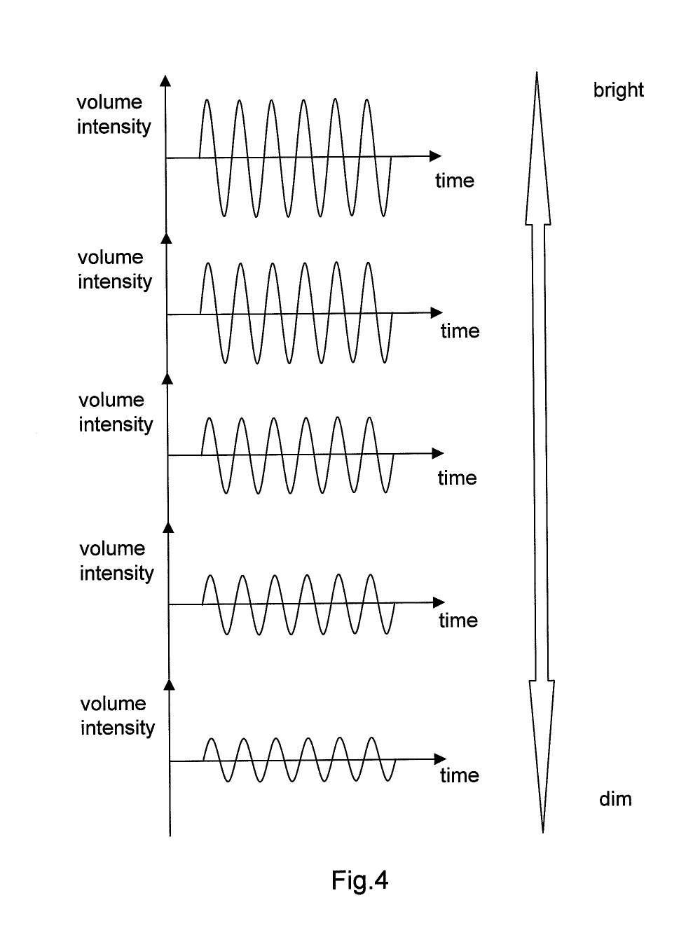

In case the respective audio signals are of different volume intensities, then as shown in FIG. 4, the audio signal waveforms can be arranged in a sequence from top to bottom based on volume intensity, that correspond to the illuminations of optical signals produced by the light emitting elements 141 to 145, from top to bottom in a sequence from brightness to dimness. Namely, the greater the volume intensity of the audio signal, the brighter the optical signal; and the less the volume intensity of the audio signal, the dimmer the optical signal.

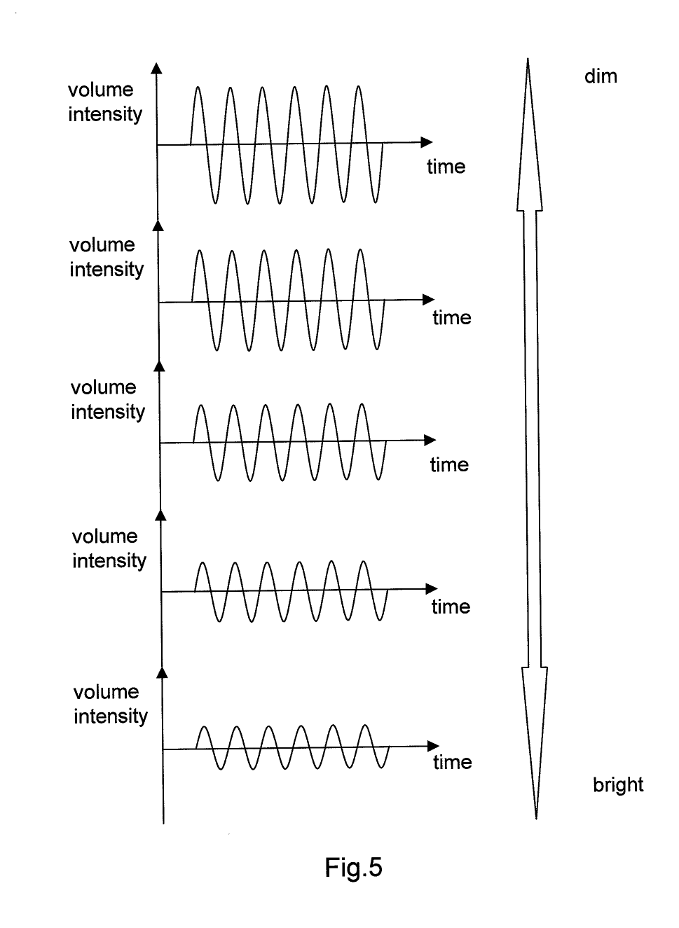

In addition, it can be set to a scheme that, the greater the volume intensity of the audio signal, the dimmer the optical signal; and the less the volume intensity of the audio signal, the brighter the optical signal. This situation is as shown in FIG. 5, wherein the audio signal waveforms are arranged in a sequence from top to bottom based on volume intensity, that correspond to the illuminations of optical signals produced by the light emitting elements 141 to 145, from top to bottom in a sequence from dimness to brightness. As such, through combining optical signals of various colors and various illuminations with the corresponding sound of music, hereby achieving lively, ideal, and in-depth audio-optical effects of the real scene, for good music entertainment and enjoyment.

Summing up the above, in the present invention, an analog approach is adopted to generate optical signals in synchronism with audio signals, in achieving a more ideal audio-optical effect.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. An audio-optical conversion device, comprising:
a plurality of audio intensity identifiers, receiving a sound signal, and each said audio intensity identifier identifies from said sound signal an audio signal of different frequency and different volume intensity, and then outputs said audio signal;
a plurality of light source drivers, each of them connected directly to each of said audio intensity identifiers, to receive corresponding said audio signal, and to convert it into an electrical signal correspondingly; and
a plurality of light emitting elements, each of them connected to each of said light source drivers, to receive corresponding said electrical signal, and generate an optical signal correspondingly.

2. The audio-optical conversion device as claimed in claim 1, wherein said electrical signal is a current signal or a voltage signal.

3. The audio-optical conversion device as claimed in claim 1, wherein said light emitting element is a light-emitting-diode (LED).

4. The audio-optical conversion device as claimed in claim 1, wherein each of said optical signals has different color.

5. The audio-optical conversion device as claimed in claim 1, wherein higher said frequency of said audio signal, cooler a color of said optical signal; and lower said frequency of said audio signal, warmer said color of said optical signal.

6. The audio-optical conversion device as claimed in claim 1, wherein higher said frequency of said audio signal, warmer a color of said optical signal; and lower said frequency of said audio signal, cooler said color of said optical signal.

7. The audio-optical conversion device as claimed in claim 1, wherein higher said volume intensity of said audio signal, brighter said optical signal; and lower said volume intensity of said audio signal, dimmer said optical signal.

8. The audio-optical conversion device as claimed in claim 1, wherein higher said volume intensity of said audio signal, dimmer said optical signal; and lower said volume intensity of said audio signal, brighter said optical signal.

9. An audio-optical conversion method, comprising following steps:
receive a sound signal, and identify from it a plurality of audio signals each having a different frequency and a different volume intensity, and output said audio signals;
receive directly and separately each said audio signal, and convert it into corresponding said electrical signal; and
receive separately said electrical signal, and generate correspondingly an optical signal.

10. The audio-optical conversion method as claimed in claim 9, wherein said electrical signal is a current signal or a voltage signal.

11. The audio-optical conversion method as claimed in claim 9, wherein each of said optical signals is of a different color.

12. The audio-optical conversion method as claimed in claim 9, wherein higher said frequency of said audio signal, cooler a color of said optical signal; and lower said frequency of said audio signal, warmer said color of said optical signal.

13. The audio-optical conversion method as claimed in claim 9, wherein higher said frequency of said audio signal, warmer a color of said optical signal; and lower said frequency of said audio signal, cooler said color of said optical signal.

14. The audio-optical conversion method as claimed in claim 9, wherein higher said volume intensity of said audio signal, brighter said optical signal; and lower said volume intensity of said audio signal, dimmer said optical signal.

15. The audio-optical conversion method as claimed in claim 9, wherein higher said volume intensity of said audio signal, dimmer said optical signal; and lower said volume intensity of said audio signal, brighter said optical signal.
